(19) United States
(12) Patent Application Publication
(10) Pub. No.: US 2013/0252102 A1
(43) Pub. Date: Sep. 26, 2013

(54) Nonaqueous Electrolyte Rechargeable Battery Having Electrode Containing Conductive Polymer

(71) Applicants: DENSO CORPORATION, Kariya-city (JP); JAPAN CARLIT CO., LTD., Tokyo (JP)

(72) Inventors: Ryuta Kobayakawa, Kariya-city (JP); Kyohei Usami, Inazawa-city (JP); Shigeki Komine, Nagoya-city (JP); Yuuki Tachibana, Chita-gun (JP); Masaaki Tamura, Shibukawa-city (JP); Tomohiko Abe, Tokyo (JP); Makoto Kodaira, Shibukawa-city (JP)

(73) Assignees: JAPAN CARLIT CO., LTD., Tokyo (JP); DENSO CORPORATION, Kariya-city (JP)

(21) Appl. No.: 13/833,980

(22) Filed: Mar. 15, 2013

(30) Foreign Application Priority Data
Mar. 20, 2012 (JP) 2012-062951
Jan. 24, 2013 (JP) 2013-011301

(51) Int. Cl. H01M 4/62

(52) U.S. Cl. CPC H01M 4/622
USPC 429/217

(57) ABSTRACT

A nonaqueous electrolyte rechargeable battery includes a positive electrode, a negative electrode, and an electrolyte solution. The positive electrode includes a positive-electrode active material that occludes and discharges an alkali metal ion. The negative electrode includes a negative-electrode active material that occludes and discharges an alkali metal ion. At least one of the positive electrode and the negative electrode contains a conductive polymer that binds the active material and provides oxidation resistance.

### CROSS REFERENCE TO RELATED APPLICATION

This application is based on Japanese Patent Applications No. 2012-62951 filed on Mar. 20, 2012 and No. 2013-011301 filed on Jan. 24, 2013, the disclosures of which are incorporated herein by reference.

### TECHNICAL FIELD

The present disclosure relates to a nonaqueous electrolyte rechargeable battery having an electrode containing a conductive polymer.

### BACKGROUND

With market expansion of electronic devices, such as laptop computers, cell phones and electronic cameras, rechargeable batteries for driving such electronic devices have been increasingly required. With regard to such electronic devices, power consumption is likely to high in accordance with high-functions, whereas it is expected to be compact. Therefore, it is required to increase the capacity of the rechargeable battery. Although there are various kinds of rechargeable batteries, a nonaqueous electrolyte rechargeable battery, such as, a lithium ion rechargeable battery is widely used in the electronic devices as a high-capacity battery.

In addition to the use of the nonaqueous electrolyte rechargeable battery in the electronic devices, it has been considered to use the nonaqueous electrolyte rechargeable battery in various other devices such as devices for vehicles and houses, which generally uses a large amount of electricity.

The nonaqueous electrolyte rechargeable battery includes a positive plate, a negative plate, and a nonaqueous electrolyte solution that is provided by dissolving an electrolyte in a nonaqueous solvent. The positive plate, the negative plate and the nonaqueous electrolyte solution are disposed (sealed) in a case as an electrode body. Also, a separator may be disposed between the positive plate and the negative plate depending on necessity. The positive plate includes a positive-electrode collector and a positive-electrode active material disposed on the positive-electrode collector. The negative plate includes a negative-electrode collector and a negative-electrode active material disposed on the negative-electrode collector.

With regard to a lithium ion rechargeable battery, which is typical as the nonaqueous electrolyte rechargeable battery, an electrode is produced by applying an electrode mixture on a surface of a collector. The electrode mixture is prepared by dispersing an electrode active material, a binder and the like in an organic solvent. The binder is used to bond the electrode active material and the like.

In general, the binder is a non-conductive material. To improve a battery output, it is necessary to enhance conductivity in the electrode. Also, it is desired to use an aqueous binder considering environmental safety and recovery of the solvent during manufacturing.

As an example of such a binder, JP2003-109596A, which corresponds to U.S. Pat. No. 6,869,730, describes a binder including a water-soluble conductive polymer (polyaniline sulfonic acid) and a water-soluble polymer (polyvinyl alcohol). The binder reduces a resistance in the electrode. As a result, an output of the rechargeable battery improves.

However, although the binder of JP2003-109596A reduces the resistance in the electrode, oxidation resistance is likely to also reduce. If the oxidation resistance reduces, a cycle characteristic of the rechargeable battery reduces.

### SUMMARY

According to an aspect of the present disclosure, a nonaqueous electrolyte rechargeable battery includes a positive electrode, a negative electrode and an electrolyte solution. The positive electrode includes a positive-electrode active material that occludes and discharges an alkali metal ion. The negative electrode includes a negative-electrode active material that occludes and discharges an alkali metal ion. At least one of the positive electrode and the negative electrode contains a conductive polymer that binds the active material and provides oxidation resistance.

In the nonaqueous electrolyte rechargeable battery according to the above aspect, at least one of the positive electrode and the negative electrode contains the conductive polymer, which functions to bind the electrode active material. Namely, the conductive polymer serves as a binder. The conductive polymer further functions to provide oxidation resistance. Since the conductive polymer not only binds the electrode active material, but also provides the oxidation resistance, an output characteristic of the electrode is maintained, and a cycle characteristic of the nonaqueous electrolyte rechargeable battery improves.

### BRIEF DESCRIPTION OF THE DRAWINGS

The above and other objects, features and advantages of the present disclosure will become more apparent from the following detailed description made with reference to the accompanying drawings, in which:

FIG. 1 is a diagram illustrating a cross-sectional view of a coin type rechargeable battery according to an embodiment of the present disclosure; and

FIG. 2 is a chart illustrating test results of rechargeable batteries of examples and comparative examples.

### DETAILED DESCRIPTION

A nonaqueous electrolyte rechargeable battery according to an embodiment includes a positive electrode, a negative electrode and an electrolyte solution. The positive electrode includes a positive-electrode active material that occludes and discharges an alkali metal ion. The negative electrode includes a negative-electrode active material that occludes and discharges an alkali metal ion. At least one of the positive electrode and the negative electrode contains a conductive polymer that binds the electrode active material and provides oxidation resistance to the electrode.

Since the conductive polymer not only binds the electrode active material, but also provides the oxidation resistance, an output characteristic of the electrode is maintained, and a cycle characteristic of the nonaqueous electrolyte rechargeable battery improves.

For example, the conductive polymer is provided by doping a dopant to a polymer composed of aniline or a derivative of the aniline (aniline-base compound) as a monomer unit. The dopant includes at least one of polystyrene sulfonic acid, a salt of the polystyrene sulfonic acid, a sulfonic acid group-containing polymer that contains aliphatic diene and a monomer that can copolymerize to the aliphatic diene as composition component, a salt of the sulfonic acid group-containing polymer, sulfonated polyester, a salt of the sulfonated polyester. The aniline is represented by a formula 1.

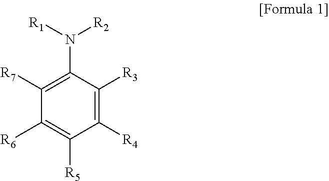

In the formula 1, R₁ to R₇ are selected from a group consisting of hydrogen, C1 to C6 straight-chain or branched alkyl group, C1 to C6 straight-chain or branched alkoxy group, hydroxyl group, nitro group, amino group, phenyl group, aminophenyl group, diphenylamino group, and halogen group. Here, C1 to C6 mean carbon numbers from 1 to 6.

In the conductive polymer having the composition described above, the dopant exerts to bind the electrode active material, and to provide conductivity of the conductive polymer and the oxidation resistance.

The dopant may not be limited to a specific one as long as the dopant provides the function of binding the electrode active material and the function of providing the oxidation resistance when the dopant is doped to the polymer. Examples of the dopant that provides the oxidation resistance are polystyrene sulfonic acid and a salt of the polystyrene sulfonic acid. Examples of the dopant that binds the electrode active material are sulfonic acid group-containing polymer that includes aliphatic diene and a monomer that can copolymerize to the aliphatic diene, a slat of the sulfonic acid group-containing polymer, sulfonated polyester, and a salt of the sulfonated polyester.

For example, the sulfonic acid group-containing polymer is selected from polyisoprene sulfonic acid, styrene butadiene copolymer sulfonic acid, and styrene isoprene copolymer sulfonic acid.

In a nonaqueous electrolyte rechargeable battery according to an embodiment, the conducive polymer is provided by a polymer in which predetermined compound is polymerized as a monomer unit, and a predetermined dopant is doped to the polymer such that the conductive polymer provides a predetermined function. In other words, by changing the dopant doped to the polymer, the function of the conductive polymer may be changed. A dopant that provides a further different function may be further doped. An example of the function may be an adsorption and desorption function of anion in the electrolyte solution.

For example, when a part of polystyrene sulfonic acid, styrene isoprene copolymer sulfonic acid or sulfonated polyester, as examples of the dopant, is reacted to lithium salt, the dope rate to the polyaniline is reduced. With this, the polyaniline adsorbs and desorbs the anion in the electrolyte solution as the active material. As a result the battery capacity increases.

For example, in the dopant of the conductive polymer, a part of or whole of the sulfonic acid group, that is, at least a part of the sulfonic acid group is masked with the alkali metal ion. With this, the dopant masked is removed, and an adsorption and desorption site of the anion is provided. Therefore, the capacity of the nonaqueous electrolyte rechargeable battery increases. The effect of improving the capacity is achieved according to a mask rate by the alkali metal ion. Further, when the dopant is masked, wettability to the collector increases, and hence the binding strength increases.

The kind of the nonaqueous electrolyte rechargeable battery according to the embodiments is not limited to a specific one. The nonaqueous electrode rechargeable battery according to the embodiments includes a positive electrode including a positive-electrode active material that occludes and discharges an alkali metal ion, a negative electrode including a negative-electrode active material that occludes and discharges an alkali metal ion, and an electrolyte solution. Further, at least one of the positive electrode and the negative electrode contains the conductive polymer. The alkali metal ions, and the positive electrode, the negative electrode are not limited to specific ones, and may have conventional structures or compositions.

In order to improve the conductivity of the conductive polymer and further to improve the characteristic of the nonaqueous electrolyte rechargeable battery, fluorine contain anion, such as bis(perfluoroalkane)sulfonylimide, bis(fluorosulfonyl)imide, annular perfluoroalkylene disulfonylimide, hexafluoride phosphorate, and tetrafluoride borate, may be used together with the dopant described above.

The alkali metal ion may be any ion of an alkali metal, such as lithium and sodium. For example, the alkali metal ion is a lithium ion.

The conductive polymer may be contained in one of the positive electrode and the negative electrode, or both of the positive electrode and the negative electrode.

In a case where the nonaqueous electrolyte rechargeable battery is a lithium ion rechargeable battery, the conductive polymer may be contained in the positive electrode. In such a case, the positive electrode contains a positive-electrode active material including a lithium transition metal composite compound and the conductive polymer.

In a case where the nonaqueous electrolyte rechargeable battery is a lithium ion rechargeable battery, the positive-electrode active material includes polyanion-type, such as iron lithium phosphate.

Hereinafter, an embodiment of the present disclosure will be described more in detail.

A nonaqueous electrolyte rechargeable battery has a structure similar to a conventional nonaqueous electrolyte rechargeable battery, except that at least one of the positive electrode and the negative electrode contains the conductive polymer described above.

For example, the negative electrode is produced in a following manner. A negative-electrode mixture including a negative-electrode active material, a conductive agent and a binder is suspended and mixed in a suitable solvent to prepare a slurry. The slurry is applied to one surface or both surfaces of a collector. The collector on which the slurry has been applied is dried. Thus, the negative electrode is produced.

The negative-electrode active material may include a carbon material. Further, the negative electrode active material may include any material other than the carbon material. For example, a material, such as graphite, providing a capacity may be used. For example, the material may be a simple substance or an alloy of a meal element of IVB group or a metalloid element in a short-period-type periodic table. For example, the material may include silicon (Si) or tin (Sn).

As the conductive agent of the negative electrode, a carbon material, metal powder, a conductive polymer and the like may be used. Considering conductivity and stability, carbon black, such as acetylene black and Ketjen black, and other carbon materials, such as vapor-grown carbon fiber (VGCF) may be used as the conductive agent.

The binder of the negative electrode is not limited to a specific one. Examples of the binder of the negative electrode may be polytetrafluoroethylene (PTFE), polyvinylidene fluoride (PVDF), fluororesin copolymer (ethylene-tetrafluoride hexafluoride propylene copolymer), SBR, acrylic-based rubber, fluorine-based rubber, polyvinyl alcohol (PVA), styrene maleic acid resin, polyacrylate, carboxyl methyl cellulose (CMC), and the like.

Examples of the solvent of the negative electrode may be an organic solvent, such as N-methyl-2-pyrrolidone (NMP), water, and the like.

The negative-electrode collector may be a known collector. For example, the negative-electrode collector may be provided by a metal foil or a metal mesh made of copper, stainless steel, titanium or nickel.

For example, the positive electrode is produced in the following manner. A positive-electrode mixture including a positive electrode active material, a conductive agent and a binder is suspended and mixed in a suitable solvent to prepare a slurry. The slurry is applied to one surface or both surfaces of a collector. The collector on which the slurry has been applied is dried. Thus, the positive electrode is produced.

As examples of the positive-electrode active material, an oxide, a sulfide, a lithium-containing oxide, a conductive polymer and the like may be used. For example, the positive-electrode active material may be LiFePO₄, LiMnPO₄, Li₂MnSiO₄, Li₂MnₓFe₁₋ₓSiO₄, MnO₂, TiS₂, TiS₃, MoS₃, FeS₂, Li₁₋ₓMnO₂, Li₁₋ₓMn₂O₄, Li₁₋ₓCoO₂, Li₁₋ₓNiO₂, LiV₂O₃, V₂O₅, polyaniline, polyparaphenylene, polyphenylene sulfide, polyphenylene oxide, polythiophene, polypyrrole, these derivatives, and a stable radical compound. In these examples of the positive-electrode active material, z is the number equal to or greater than 0 and equal to or less than 1. Further, in these examples, Li, Mg, Al or a transition metal, such as Co, Ti, Nb, or Cr, may be added to or substituted for each element. These lithium-metal composite oxides may be solely used. Alternatively, a plurality of kinds of these oxides may be mixed and used together. Among these examples, the lithium-metal composite oxide may be one or more elements selected from lithium manganese-containing multiple oxide having a lamination structure or a spinel structure, lithium nickel-containing multiple oxide, and lithium cobalt-containing multiple oxide. In the present embodiment, as the positive-electrode active material, a polyanion-type, such as iron lithium phosphate, is used.

The conductive agent of the positive electrode is not limited to a specific one, but may be fine particles of graphite, carbon black, such as acetylene black, Ketjen black, and carbon nano fiber, and fine particles of amorphous carbon, such as needle coke.

As the binder, a case where the conductive polymer of the present disclosure is used, PVDF, ethylene-propylene-diene copolymer (EPDM), SBR, acrylonitrile-butadiene rubber (NBR), and fluororubber may be added in addition to the examples of the binder of the negative electrode described above.

As the solvent for dispersing the positive-electrode material and the like, an organic solvent for dissolving the binder is generally used. The solvent of the positive electrode is not limited to a specific one, but may be NMP, dimethylformamide, dimethylacetamide, methyl ethyl ketone, cyclohexanone, methyl acetate, methyl acrylate, diethyltriamine, N—N-dimethylaminopropylamine, ethylene oxide, tetrahydrofuran and the like. The solvent may be provided by a slurry that is made by adding a thickener and a dispersion agent such as carboxymethylcellulose (CMC) to water.

The electrolyte solution of the present embodiment has a similar composition to a known nonaqueous electrolyte solution, except that the electrolyte solution of the present embodiment is a liquid where an electrolyte is dissolved in a solvent that contains at least one selected from EC, VC, DMC, EMC, and DMC as a main material. The electrolyte dissolved in the electrolyte solution may be an electrolyte that is used in a known nonaqueous electrolyte solution.

The electrolyte is not limited to a specific one, but may be at least one of an inorganic salt selected from LiPF₆, LiBF₄, LiClO₄, and LiAsF₆, a derivative of these inorganic salts, and an organic salt selected from LiSO₃CF₃, LiC(SO₃CF₃)₃, LiN(SO₂CF₃)₂, LiN(SO₂C₂F₅)₂, and LiN(SO₂CF₃)(SO₂C₄F₉), and a derivative of these organic salts. These electrolytes contribute to further improve a battery performance and to keep the battery performance also in a temperature region other than a room temperature. The concentration of the electrolyte may not be limited to a specific concentration. The concentration may be suitably decided depending on use of the rechargeable battery, considering the kinds of the electrolyte and the organic solvent.

The nonaqueous electrolyte rechargeable battery of the present embodiment may include a separator as an electrical insulator to insulate the positive electrode and the negative electrode from one another, and to hold the electrolyte solution. For example, the separator may be provided by a porous synthetic resin film, such as a porous film of polyolefin-based polymer (e.g., polyethylene, polypropylene). Since the separator needs to keep the insulation between the positive electrode and the negative electrode, the size of the separator may be greater than the positive electrode and the negative electrode.

The nonaqueous electrolyte rechargeable battery may include other elements, in addition to the elements described above. The shape of the nonaqueous electrolyte rechargeable battery of the present embodiment may not be limited to a specific one. For example, the nonaqueous electrolyte rechargeable battery may have a coin-cell shape, a cylindrical shape, a square or rectangular shape, or any other shape. Also, a shape and a material of a case of the nonaqueous electrolyte rechargeable battery of the present embodiment may not be limited to specific ones. The case may be made of a metal or a resin. The case may be provided by a soft case such as a laminate package. The case may be provided by any other formation as long as an outer shape of the rechargeable battery can be kept.

### <Manufacturing Method>

A manufacturing method of the nonaqueous electrolyte rechargeable battery of the present embodiment is not limited to a specific method. For example, the nonaqueous electrolyte rechargeable battery of the present embodiment may be manufactured by a known method of a conventional nonaqueous electrolyte rechargeable battery, except that the conductive polymer described above is added as the binder.

### EXAMPLES

The nonaqueous electrolyte rechargeable battery of the embodiment will be hereinafter described in detail based on the following examples.

As examples of the nonaqueous electrolyte rechargeable battery of the present disclosure, coin-type lithium ion rechargeable batteries were prepared. The followings are examples to implement the present disclosure, and the present disclosure is not limited to the following examples. In the following description, “%” represents “mass %”.

<Synthesis of Polyaniline Water Dispersion (1)>

100 mmol aniline, 84 g of 18% polystyrene sulfonic acid aqueous solution and 100 g of 15% styrene-isoprene copolymer sulfonic acid aqueous solution, which are as the dopant, 0.5 mmol ruthenium chloride(III) as a reaction catalyst, and 2.5 mmol pyridine as a reaction accelerator were inserted in 846 g of an ion exchange water, and stirred well at 40 degrees Celsius to mix together. In this solution, 11.3 g of 30% oxygenated water was slowly added while stirring, and a reaction was carried out at 40 degrees Celsius for four hours. As a result, uniform green polyaniline water dispersion (1) was produced.

A particle diameter of the polyaniline water dispersion (1) was measured by a particle counter (e.g., NANOTRACK UPA-EX150, NIKKISO CO., LTD). As a result, 50% accumulation particle diameter was 300 nm. Further, when this dispersion was spin-coated on a glass substrate and dried, a uniform polyaniline coating was produced. A surface resistivity of the coating was measured by a resistivity meter (e.g., Hiresta UP Model MCP-HT450, MITSUBISHI CHEMICAL ANALYTECH CO., LTD). As a result, the surface resistivity of the coating was 1.5×10⁷ Ω/□ (Ω/sq.).

<Synthesis of Polyaniline Water Dispersion (2)>

100 mmol aniline, 50 g of 18% polystyrene sulfonic acid aqueous solution and 140 g of 15% styrene-isoprene copolymer sulfonic acid aqueous solution, which are as the dopant, 0.5 mmol ruthenium chloride(III) as a reaction catalyst, and 2.5 mmol pyridine as a reaction accelerator were inserted in 840 g of an ion exchange water, and stirred well at 40 degrees Celsius to mix together. This solution was reacted, in a similar manner to the polyaniline water dispersion (1), and thus uniform green polyaniline water dispersion (2) was produced.

The particle diameter and the surface resistivity of the coating of the polyaniline water dispersion (2) were measured, in similar manners to the polyaniline water dispersion (1). As a result, the particle diameter and the surface resistivity of the coating of the polyaniline water dispersion (2) were 450 nm and 3.0×10⁸ Ω/sq.

<Synthesis of Polyaniline Water Dispersion (3)>

100 mmol aniline, 117 g of 18% polystyrene sulfonic acid aqueous solution and 60 g of 15% styrene-isoprene copolymer sulfonic acid aqueous solution, which are as the dopant, 0.5 mmol ruthenium chloride(III) as a reaction catalyst, and 2.5 mmol pyridine as a reaction accelerator were inserted in 853 g of an ion exchange water, and stirred well at 40 degrees Celsius to mix together. This solution was reacted, in a similar manner to the polyaniline water dispersion (1), and thus uniform green polyaniline water dispersion (3) was produced.

The particle diameter and the surface resistivity of the coating of the polyaniline water dispersion (3) were measured, in similar manners to the polyaniline water dispersion (1). As a result, the particle diameter and the surface resistivity of the coating of the polyaniline water dispersion (3) were 250 nm and 5.0×10⁶ Ω/sq.

<Synthesis of Polyaniline Water Dispersion (4)>

5.8 g of lithium hydroxide 1 hydrate was added little by little to the polyaniline water dispersion (3). Thus, a polyaniline water dispersion (4) in which 90% of sulfonic acid group of the dopant are masked with lithium was produced.

The particle diameter and the surface resistivity of the coating of the polyaniline water dispersion (4) were measured, in similar manners to the polyaniline water dispersion (1). As a result, the particle diameter and the surface resistivity of the coating of the polyaniline water dispersion (4) were 250 nm and 2.0×10¹¹ Ω/sq.

<Synthesis of Polyaniline Water Dispersion (5)>

3.2 g of lithium hydroxide 1 hydrate was added little by little to the polyaniline water dispersion (3). Thus, a polyaniline water dispersion (5) in which 50% of sulfonic acid group of the dopant are masked with lithium was produced.

The particle diameter and the surface resistivity of the coating of the polyaniline water dispersion (5) were measured, in similar manners to the polyaniline water dispersion (1). As a result, the particle diameter and the surface resistivity of the coating of the polyaniline water dispersion (5) were 250 nm and 8.0×10⁹ Ω/sq.

<Synthesis of Polyaniline Water Dispersion (6)>

100 mmol aniline, 117 g of 18% polystyrene sulfonic acid aqueous solution and 45 g of 20% sulfonated polyester aqueous solution, which are as the dopant, 0.5 mmol ruthenium chloride(III) as a reaction catalyst, and 2.5 mmol pyridine as a reaction accelerator were inserted in 868 g of an ion exchange water, and stirred well at 40 degrees Celsius to mix together. This solution was reacted, in a similar manner to the polyaniline water dispersion (1), and uniform green polyaniline water dispersion (6) was produced.

The particle diameter and the surface resistivity of the coating of the polyaniline water dispersion (6) were measured, in similar manners to the polyaniline water dispersion (1). As a result, the particle diameter and the surface resistivity of the coating of the polyaniline water dispersion (6) were 400 nm and 1.0×10⁷ Ω/sq.

<Synthesis of Polyaniline Water Dispersion (7)>

100 mmol aniline, 167 g of 18% polystyrene sulfonic acid aqueous solution as the dopant, 0.5 mmol ruthenium chloride(III) as a reaction catalyst, and 2.5 mmol pyridine as a reaction accelerator were inserted in 863 g of an ion exchange water, and stirred well at 40 degrees Celsius to mix together. This solution was reacted, in a similar manner to the polyaniline water dispersion (1), and thus uniform green polyaniline water dispersion (7) was produced.

The particle diameter and the surface resistivity of the coating of the polyaniline water dispersion (7) were measured, in similar manners to the polyaniline water dispersion (1). As a result, the particle diameter and the surface resistivity of the coating of the polyaniline water dispersion (7) were 200 nm and 1.5×10⁶ Ω/sq.

<Synthesis of Polyaniline Water Dispersion (8)>

100 mmol aniline, 200 g of 15% styrene isoprene copolymer sulfonic acid aqueous solution as the dopant, 0.5 mmol ruthenium chloride(III) as a reaction catalyst, and 2.5 mmol pyridine as a reaction accelerator were inserted in 830 g of an ion exchange water, and stirred well at 40 degrees Celsius to mix together. This solution was reacted, in a similar manner to the polyaniline water dispersion (1), and thus uniform green polyaniline water dispersion (8) was produced.

The particle diameter and the surface resistivity of the coating of the polyaniline water dispersion (8) were measured, in similar manners to the polyaniline water dispersion (1). As a result, the particle diameter and the surface resistivity of the coating of the polyaniline water dispersion (8) were 550 nm and 4.0×10⁹ Ω/sq.

<Synthesis of Polyaniline Water Dispersion (9)>

100 mmol aniline, 150 g of 20% sulfonated polyester aqueous solution as the dopant, 0.5 mmol ruthenium chloride(III) as a reaction catalyst, and 2.5 mmol pyridine as a reaction accelerator were inserted in 880 g of an ion exchange water, and stirred well at 40 degrees Celsius to mix together. This solution was reacted, in a similar manner to the polyaniline water dispersion (1). However, uniform dispersion was not produced.

### Example 1

A coin-type lithium rechargeable battery as an example 1 was prepared in the following manner.

<Production of Positive Electrode>

A uniform coating fluid as a slurry was prepared by mixing and dispersing a positive-electrode active material, a binder, a conductive agent and a dispersion agent in a solvent. As the positive-electrode active material, 90 parts by mass of LiFePO₄was added. As the binder, the polyaniline water dispersion (1) was added such that 3 parts by mass of the polymer (polymer composed of polyaniline, polystyrene sulfonic acid, and styrene isoprene copolymer sulfonic acid) is contained in the fluid. As the conductive agent, 4 parts by mass of acetylene black and 2 parts by mass of the vapor-grown carbon fiber were added. As the dispersion agent, 1 part by mass of carboxymethylcellulose (CMC) was added.

The prepared slurry was applied to the positive-electrode collector composed of an aluminum thin film, dried and pressed. Thus, a positive electrode plate was prepared. The positive electrode plate was prepared such that the positive-electrode mixture has a thickness of 41 μm. In preparation of the slurry, water was used as the solvent.

In the positive-electrode mixture produced, a bonding strength of the active material to the collector was measured by an intensity testing device. As a result, the bonding strength was 108 N.

<Preparation of Electrolyte Solution>

An electrolyte solution was prepared by adding LiPF₆ in an organic solvent in which ethylene carbonate (EC) and diethyl carbonate (DEC) are mixed at a mass ratio of 3:7. In this case, LiPF₆ was added to the organic solvent such that the concentration of LiPF₆ is 1.0 mol/L.

<Production of Coin-Type Lithium Rechargeable Battery>

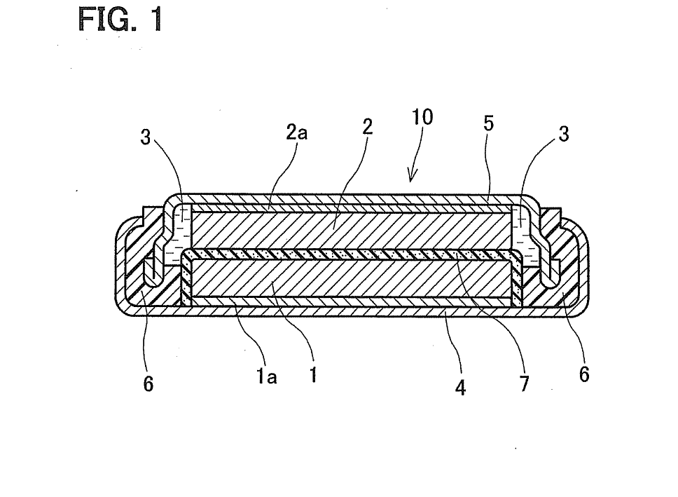

As shown in FIG. 1, the coin-type lithium rechargeable battery 10 was produced using the above-described materials. The lithium rechargeable battery 10 includes a positive electrode 1, a negative electrode 2, an electrolyte solution 3, and a separator 7. The positive electrode 1 is provided by the positive electrode produced as described above. The negative electrode 2 is made of a lithium metal. The electrolyte solution 3 is provided by the electrolyte solution prepared as described above. The separator 7 is made of a porous polyethylene film having a thickness of 25 μm. The positive electrode 1 includes a positive-electrode collector 1a. The negative electrode 2 includes a negative-electrode collector 2a.

These power-generation elements are disposed in a stainless case. The case is made of a positive-electrode case 4 and a negative-electrode case 5, for example. The positive-electrode case 4 serves as a positive-electrode terminal. The negative-electrode case 5 serves as a negative-electrode terminal. A polypropylene gasket 6 is disposed between the positive-electrode case 4 and the negative-electrode case 5 to seal between the positive-electrode case 4 and the negative-electrode case 5, and to keep electric insulation between the positive-electrode case 4 and the negative-electrode case 5.

<Evaluation of Capacitance Characteristic and Output Characteristic>

The lithium rechargeable battery 10 produced as the example 1 was charged to 4.1 V with an electric current corresponding to 1C, and then discharged to 3.0 V with an electric current corresponding to 1C. In this state, The discharge capacity (initial capacity) was measured.

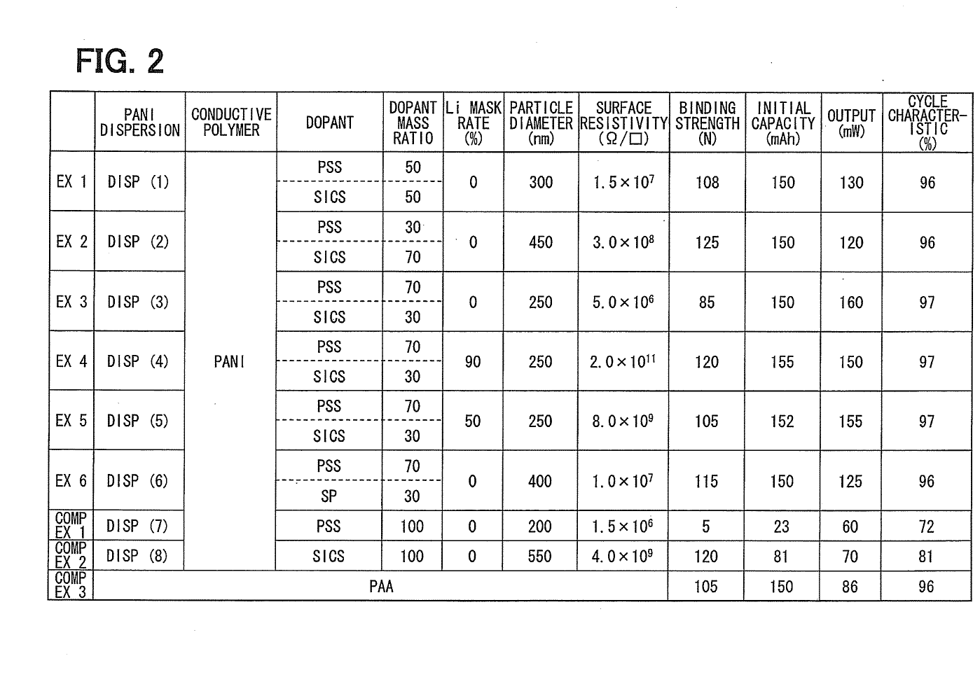

To evaluate the output characteristic, a state of charge (SOC) of the rechargeable battery was adjusted to SOC 60% by a constant current charge of 330 μA, and a discharging current of the lithium rechargeable battery was changed while setting an operation lower limit voltage of the SOC 60% at 2.5 V. The voltage at 10 seconds after the beginning of discharging was calculated, and the battery output was obtained based on the calculated voltage. The evaluation results of the discharge capacity and the output are shown in FIG. 2.

As a result, the discharge capacity per mass of the positive-electrode mixture was 150 mAh/g and the battery output was 130 mW, as shown in FIG. 2.

Further, a capacity after 100 testing cycles are repeated was measured. In one testing cycle, the battery was charged from 2.1 V to 4.1 V and was discharged from 4.1 V to 2.1 V under a condition of 60 degrees Celsius. A maintenance rate relative to the initial capacity was measured. The results are shown FIG. 2 together with the cycle characteristic.

In FIG. 2, “PSS” represents polystyrene sulfonic acid, “SICS” represents styrene isoprene copolymer sulfonic acid, and “SP” represents sulfonated polyester. Also, “PAA” represents polyacrylic acid.

### Example 2

A lithium rechargeable battery as an example 2 was produced in the similar manner to the example 1, except that the polyaniline water dispersion (2) was used as the binder. The respective characteristics were measured in the similar manner to the example 1.

As a result, the bonding strength of the positive-electrode active material was 125 N. The discharge capacity per mass of the positive-electrode mixture was 150 mAh/g, and the battery output was 120 mW. The results are shown in FIG. 2.

### Example 3

A lithium rechargeable battery as an example 3 was produced in the similar manner to the example 1, except that the polyaniline water dispersion (3) was used as the binder. The respective characteristics were measured in the similar manner to the example 1.

As a result, the bonding strength of the positive-electrode active material was 85 N. The discharge capacity per mass of the positive-electrode mixture was 150 mAh/g, and the battery output was 160 mW. The results are shown in FIG. 2.

### Example 4

A lithium rechargeable battery as an example 4 was produced in the similar manner to the example 1, except that the polyaniline water dispersion (4) was used as the binder. The respective characteristics were measured in the similar manner to the example 1.

As a result, the bonding strength of the positive-electrode active material was 120 N. The discharge capacity per mass of the positive-electrode mixture was 155 mAh/g, and the battery output was 150 mW. The results are shown in FIG. 2.

### Example 5

A lithium rechargeable battery as an example 5 was produced in the similar manner to the example 1, except that the polyaniline water dispersion (5) was used as the binder. The respective characteristics were measured in the similar manner to the example 1.

As a result, the bonding strength of the positive-electrode active material was 105 N. The discharge capacity per mass of the positive-electrode mixture was 152 mAh/g, and the battery output was 155 mW. The results are shown in FIG. 2.

### Example 6

A lithium rechargeable battery as an example 6 was produced in the similar manner to the example 1, except that the polyaniline water dispersion (6) was used as the binder. The respective characteristics were measured in the similar manner to the example 1.

As a result, the bonding strength of the positive-electrode active material was 115 N. The discharge capacity per mass of the positive-electrode mixture was 150 mAh/g, and the battery output was 125 mW. The results are shown in FIG. 2.

### Comparative Example 1

A lithium rechargeable battery as a comparative example 1 was produced in the similar manner to the example 1, except that the polyaniline water dispersion (7) was used as the binder. The respective characteristics were measured in the similar manner to the example 1.

As a result, the bonding strength of the positive-electrode active material was 5 N. The discharge capacity per mass of the positive-electrode mixture was 23 mAh/g, and the battery output was 60 mW. The results are shown in FIG. 2.

### Comparative Example 2

A lithium rechargeable battery as a comparative example 2 was produced in the similar manner to the example 1, except that the polyaniline water dispersion (8) was used as the binder. The respective characteristics were measured in the similar manner to the example 1.

As a result, the bonding strength of the positive-electrode active material was 120 N. The discharge capacity per mass of the positive-electrode mixture was 81 mAh/g, and the battery output was 70 mW. The results are shown in FIG. 2.

### Comparative Example 3

A lithium rechargeable battery as a comparative example 3 was produced in the similar manner to the example 1, except that the polyacrylic acid was used as the binder. The respective characteristics were measured in the similar manner to the example 1.

As a result, the bonding strength of the positive-electrode active material was 105 N. The discharge capacity per mass of the positive-electrode mixture was 150 mAh/g, and the battery output was 86 mW. The results are shown in FIG. 2.

As shown in FIG. 2, it is appreciated that the binder in which the conductive polymer is the polyaniline (PANI) and to which the dopant exerting a function of binding the positive-electrode active material (e.g., styrene isoprene copolymer sulfonic acid) and the dopant exerting a function of providing the oxidation resistance (e.g., polystyrene sulfonic acid) are both doped has a low surface resistivity and high binding strength.

In regard to the batteries of the examples 4, 5, a part of the dopant is separated from the polyaniline by the mask treatment, and an adsorption and desorption site of the anion (e.g., PF6⁻) is provided. Therefore, the capacity is provided according to the mask rate. Further, it is appreciated that the wettability to the collector improves, and the binding strength increases.

Further, it is appreciated that the batteries of the examples 1 to 6 have excellent characteristic in regard to each of the initial capacity, the output and the cycle characteristic.

On the other hand, with regard to the binder of the comparative example 1 in which only the polystyrene sulfonic acid is doped as the dopant, it is appreciated that the binding strength is too small. Also, it is appreciated that the battery of the comparative example 1 is insufficient in regard to each of the initial capacity, the output and the cycle characteristic, as compared to the examples 1 to 6.

With regard to the binder of the comparative example 2 in which only the styrene isoprene copolymer sulfonic acid is doped as the dopant, it is appreciated that the binding strength is sufficient. However, the initial capacity, the output and the cycle characteristic of the battery of the comparative example 2 are insufficient.

With regard to the battery of the comparative example 3 in which the polyacrylic acid is used as the binder, the binding strength is substantially the same level as that of the examples 1 to 6. However, the initial capacity and the output are lower than those of the examples 1 to 6.

As described above, with regard to the coin-type lithium rechargeable batteries of the examples 1 to 6, it is appreciated that resistance characteristic of the electrode and the cycle characteristic are improved.

The advantageous effects of the examples described above are achieved irrespective of composition of the electrodes. Therefore, the present embodiment may not be limited by a composition ratio of materials forming the electrode.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A nonaqueous electrolyte rechargeable battery comprising:
a positive electrode having a positive-electrode active material that occludes and discharges an alkali metal ion;
a negative electrode having a negative-electrode active material that occludes and discharges an alkali metal ion; and
an electrolyte solution, wherein
at least one of the positive electrode and the negative electrode contains a conductive polymer that binds the active material of the at least one of the positive electrode and the negative electrode, and provides oxidation resistance.

2. The nonaqueous electrolyte rechargeable battery according to claim 1, wherein
the conductive polymer is a polymer provided by polymerization of one of aniline and a derivative of the aniline as a monomer unit and to which a dopant is doped,
wherein the aniline is represented by formula 1, 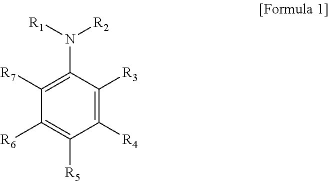
in which R₁ to R₇ are selected from the group consisting of hydrogen, straight-chain or branched alkyl group a carbon number of which is from 1 to 6, straight-chain or branched alkoxy group a carbon number of which is from 1 to 6, hydroxyl group, nitro group, amino group, phenyl group, amino phenyl group, diphenyl amino group and halogen group, and
wherein the dopant includes polystyrene sulfonic acid or a salt of the polystyrene sulfonic acid, and at least one of: a sulfonic acid group-containing polymer composed of aliphatic diene and a monomer that can copolymerize to the aliphatic diene as a composition component; a salt of the sulfonic acid group-containing polymer; sulfonated polyester; and a salt of the sulfonated polyester.

3. The nonaqueous electrolyte rechargeable battery according to claim 2, wherein
the sulfonic acid group-containing polymer is selected from the group consisting of polyisoprene sulfonic acid, styrene butadiene copolymer sulfonic acid, and styrene isoprene copolymer sulfonic acid.

4. The nonaqueous electrolyte rechargeable battery according to claim 2, wherein
in the dopant doped in the conductive polymer, at least a part of sulfonic acid group is masked with the alkali metal ion.

5. The nonaqueous electrolyte rechargeable battery according to claim 1, wherein the alkali metal ion is a lithium ion.

6. The nonaqueous electrolyte rechargeable battery according to claim 1, wherein
the positive-electrode active material includes a lithium transition metal composite compound, and
the conductive polymer is contained in the positive electrode.
